(19) United States
(12) Patent Application Publication
(10) Pub. No.: US 2003/0217588 A1
(43) Pub. Date: Nov. 27, 2003

(54) Handheld device for intrusive and non-intrusive field measurements of air permeability of soil

(76) Inventors: Marc Jalbert, Arpajon/Cere (FR); Jacob H. Dane, Auburn, AL (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/444,802

(22) Filed: May 23, 2003

Related U.S. Application Data
(60) Provisional application No. 60/382,732, filed on May 23, 2002.

(51) Int. Cl. G01N 15/08

(52) U.S. Cl. 73/38

(57) ABSTRACT

A rugged, handheld, single-reading device, for fast measurement of soil surface air permeability; and methods utilizing empirical relationships, involving geometric factors and voltage readings to quickly convert the latter to air permeability values. Use of a contact probe and an insertion probe are evaluated, and air permeability values determined with the contact and the insertion probe were found comparable for dry porous media.

### CROSS-REFERENCE TO RELATED APPLICATIONS

This application claims the benefit of U.S. Provisional Patent Application Serial No. 60/382,732, filed May 23, 2002; which application is incorporated herein by reference in its entirety for all purposes.

### FIELD OF THE INVENTION

The present invention relates generally to the field of soil science, and more particularly to improved devices and methods for measuring and analysis of in situ air permeability of soil.

### BACKGROUND OF THE INVENTION

Air permeability has long been a parameter of interest to soil scientists. Air permeability is of direct importance in gas transport studies. Its values can also be used as indicators of soil hydraulic conductivity. Near the soil surface, both air and water permeability values are important for hydrological and agricultural studies involving, e.g., soil aeration and water run-off during rainfall events. It is of direct importance when studying topics such as transport of volatile organic compounds in the subsurface, or soil-atmosphere gas exchange, a subject of interest to agriculture and the turf grass industry. Furthermore, extensive air permeability measurements can provide useful information about the hydraulic conductivity distribution at the field or catchment scale. Notably, the permeability of the soil surface is important to hydrologists and soil conservationists, as it affects phenomena such as water runoff and soil erosion.

Parallel to efforts undertaken by the soil science community in the field of air permeametry, a great deal of research has been performed by petroleum scientists to assess the conductive properties of oil reservoirs to fluids such as brine, crude oil, and gas. Because of its simpler use, air has traditionally been preferred to water or oil for estimating the intrinsic permeability of core samples. Quite recently, numerous studies in the petroleum literature encouraged the use of so-called mini-permeameters (or probe permeameters) to study the air permeability structure of rock samples in the laboratory, or of geologic outcrops in situ. The devices used in the field often comprise a source of pressurized nitrogen, together with electronic or mechanical flow meters and manometers. Such devices typically are connected to a probe that simply comes in contact with the surface of the porous medium of interest. Measurements performed by such methods, although limited to near-surface sampling volumes, have the advantage of being rapid and non-intrusive.

It has been found desirable to adapt and improve upon previously known devices and methods for use in soil air permeability measurement and analysis. It is to the provision of devices and methods meeting this and other needs that the present invention is primarily directed.

### SUMMARY OF THE INVENTION

Briefly described, the present invention provides improved devices and methods for measurement and analysis of soil air permeability. In an example embodiment, the invention comprises a small, lightweight, rugged, battery-powered, handheld, single-reading device adapted to rapid field determination of soil air permeability near the soil surface in the approximate range of 5-150 μm². The device preferably includes two interchangeable air probes, one a contact probe, as disclosed in petroleum engineering literature, and the other a traditional insertion probe.

In-situ measurement of air permeability according to example methods of the present invention take into consideration the concept of the probe geometric factor. Empirical relationships are disclosed herein to facilitate the application of this concept. Relative differences in air permeability values obtained with the two probes have been found to be acceptable in practice for permeability measurements. Although in many cases, contact probe air permeability values were found to be higher than insertion probe values, no clear trend existed, and the differences are believed to be attributable to differences in soil compaction, by-pass flow, and different measurement volumes associated with the two probe types. For the flow rates and pressures encountered during the measurements, the flow rate generally behaved as a linear function of the pressure gradient. In other words, an assumed Darcy-type equation was confirmed to be applicable to use in connection with the methods and devices of the present invention.

In one aspect, the invention is a device for measuring air permeability of soil. The device preferably includes a contact probe, an insertion probe, a pump for pumping a fluid to a selected one of the contact probe and the insertion probe, a pressure transducer for measuring a pressure differential, and an output device for reporting the measured pressure differential.

In another aspect, the invention is a device for measuring the permeability of soil, the device preferably including a pump for delivering a fluid under pressure, a detachable coupling for delivering the fluid under pressure from the pump to a probe selected from a contact probe and an insertion probe, and means for measuring a pressure of the fluid delivered to the selected probe and determining a soil permeability value based on the measured pressure.

In yet another aspect, the invention is a method of determining the permeability of soil. The method preferably includes the steps of providing a soil permeability measurement device with interchangeable probes including a contact probe and an insertion probe, delivering a fluid under pressure to a selected one of the contact probe and the insertion probe, and measuring a pressure of the fluid delivered to the selected probe and determining a soil permeability value based on the measured pressure.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWING FIGURES

FIG. 1 shows a schematic diagram of an air permeameter device according to an example embodiment of the present invention.

FIG. 2a shows a cross-sectional schematic view of an insertion probe for use in connection with a device and method for measuring soil air permeability according to an example embodiment of the present invention.

FIG. 2b shows a cross-sectional schematic view of a contact probe for use in connection with a device and method for measuring soil air permeability according to an example embodiment of the present invention.

FIG. 3 is a table of the geometric factor for contact probes as a function of probe dimensions.

FIG. 4 graphs the geometric factor G as a function of the probe dimension D/H, with solid circles depicting Hydrus-2D simulations and a solid line representing Equation [4] herein.

FIG. 5a graphs the permeameter characteristic curve for a 1.5 V DC pump-based embodiment of a device according to an example embodiment of the present invention.

FIG. 5b graphs the permeameter characteristic curve for a 120 V AC pump-based embodiment of a device according to an example embodiment of the present invention.

FIG. 6 shows a comparison of experimental air permeability values obtained using a contact probe and an insertion probe in connection with a device and method according to an example embodiment of the present invention, in coarse sand (CS); medium sand (MS); fine sand (FS); very fine sand (VFS); loam soil high in organic matter (TNH); sandy loam high in organic matter (ALH); and sandy loam low in organic matter (TNL).

FIG. 7 is a table of air permeability values measured in situ with an insertion probe (tin can and/or modified cup cutter on a medium sand (MS), a very course sand (VCS) and a sandy loam soil (SL), the numbers in parentheses referring to the number of measurements.

FIG. 8a graphs the airflow rate Q as a function of the pressure difference ΔP across a packed sand column using a 1.5 V DC air pump (r²=0.984).

FIG. 8b graphs the airflow rate Q as a function of the pressure difference ΔP across a packed sand column using a 120 V AC air pump (r²=0.992).

FIG. 9 is a table of air permeability values for different combinations of air flowrate and pressure gradient (probe vs. atmosphere), their average values, and their corresponding water permeability values.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

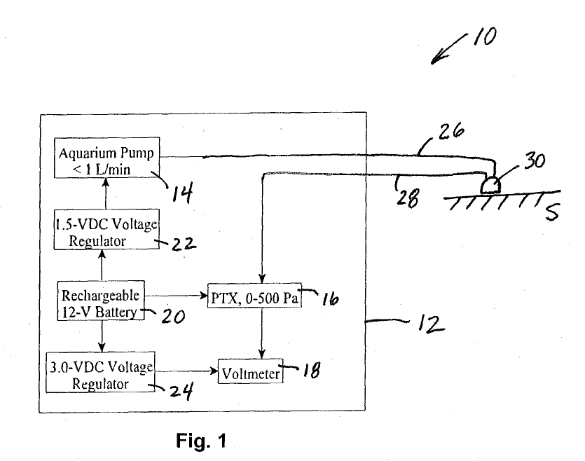

In an example embodiment of the invention shown schematically in FIG. 1, the air permeameter 10 of the present invention comprises a box or housing 12, preferably formed of a plastic, metal or other material sufficiently durable to protect interior components, and relatively lightweight and portable, for example having exterior dimensions of about 25×19×8 cm. The housing 12 preferably contains components including a 1.5-V DC battery-powered air pump 14 (for example a Hagen aquarium pump, model #A-790 having a nominal flow rate of about 1 L/min), a low-pressure differential pressure transducer 16 (for example a Cole-Parmer transducer by Auto Tran Inc., model 600D-012, 0-500 Pa), and a 3.0-V commercial voltmeter 18 or other display means for outputting a measured pressure differential. The example embodiment depicted preferably also comprises a 12-V rechargeable battery 20, which provides power to the pump 14, the pressure transducer 16 and the voltmeter 18. The voltage is preferably reduced and stabilized by one or more transistor-based regulators 22, 24.

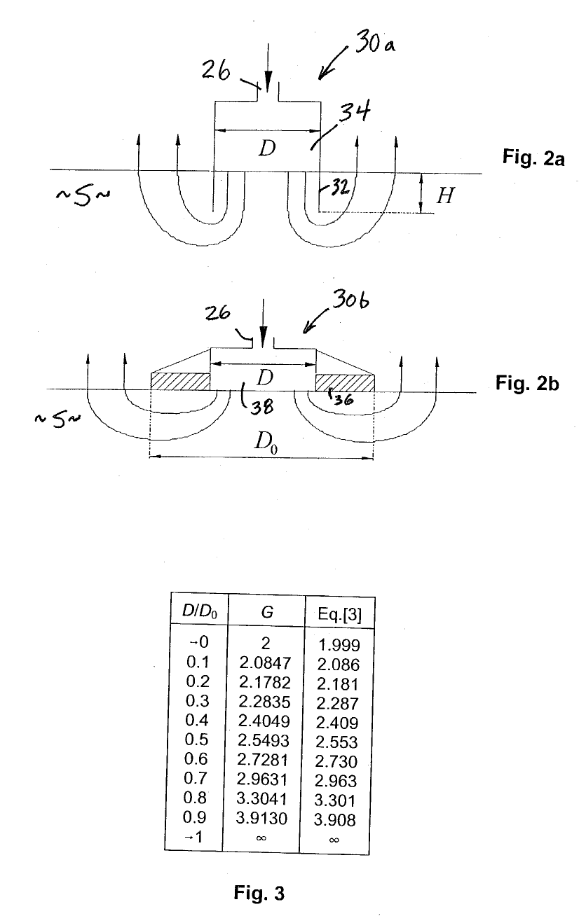

Tygon tubing or other conduit 26 preferably operably connects the pump 14 to a soil probe 30 for application to the soil S under analysis. The probe 30 is preferably either an insertion probe 30a (FIG. 2a), having walls 32 bounding a plenum 34 for insertion into the soil S; or a contact probe 30b (FIG. 2b) having a rim 36 for sealing contact with the soil S to define an interior plenum 38. A second length of Tygon tubing or other conduit 28 preferably operably connects the probe 30 to the pressure transducer 16. To reduce the cost and complexity of the device, no flow rate control is necessary or included in the depicted embodiment. In alternate embodiments, flow rate control means optionally are provided. The single-reading design of example embodiments of the invention that omit flow rate control advantageously allows for easy automatization of the data acquisition process when using a voltmeter in combination with a data acquisition system, and is suitable for use in conjunction with a GPS (Global Positioning System).

When the air permeameter is in use, the air pressure drop between the inside of the probe above the soil surface (within the plenum 34 or 38) and the free atmosphere, due to friction forces in the soil, is measured with the 0-500 Pa differential pressure transducer, of which the electrical output is displayed by the voltmeter. Sintered glass and cotton plugs (15 mm long) are preferably included as filters and pressure fluctuation dampers in the air lines between the pressure transducer and the probe and between the pressure transducer and the atmosphere. In example embodiments of the invention that have been constructed, the device 10 within housing 12 weighs about 1700 grams (excluding the tubing and probe). The device can include one or more handles or grips, and preferably can be handheld and oriented in any direction, which is in contrast with some other devices comprising mechanical parts affected by gravity, such as liquid manometers, mechanical flowmeters, or gravity-driven syringes. Although the device and method of the present invention are primarily described herein as delivering air to the sample site for permeability analysis, in alternate embodiments compressed nitrogen or other gases, water, and/or other fluid(s) can be used.

Two types of probes are used in example embodiments of the device and method of the present invention. The first type, the insertion probe has traditionally been used in soil science, and is typically used with relatively soft surfaces. This probe consists of a metal cylinder 32, with inside diameter D, which is inserted into the soil to depth H (FIG. 2a). A first prototype cylinder consisted of an upside-down tin can. This design was later changed to use a modified golf course cutting cup sampler, which allowed for much easier insertion into the soil than the tin can. The bottom edge of the cutting cup sampler was made smooth and sharpened to insure good sealing between probe and soil. This design also included an adjustable guide to allow for preset insertion depths. Example dimensions of an insertion probe found to produce suitable results are an inside diameter D of about 95 mm and an insertion depth H of about 25 mm. The second type probe, the contact probe, corresponds to the non-intrusive surface probes used in the petroleum literature, and is typically used with relatively hard surfaces. Prototype embodiments of the probe consist of a foam rubber annulus or rim 36 of internal diameter D and external diameter D₀, glued to a large rubber stopper to support the foam rubber annulus (FIG. 2b). The annulus or rim 36 is preferably formed of foam rubber or other compressible material(s) so that it conforms to the contours of the surface against which it is pressed with moderate hand pressure to form a fluid-tight seal. Example dimensions of a contact probe found to produce suitable results are an internal diameter D of about 25 mm and an external diameter D₀ of about 65 mm. In example embodiments, both an insertion probe and a contact probe are provided in fluid connection with the device 10 of the present invention, and valving is provided for selectively switching one or the other of the probes into use. In other embodiments, a quick-connect detachable coupling is provided to allow interchangability of the insertion probe and the contact probe.

The characteristics of the pump 14 preferably do not change to any significant extent over time. In an alternate embodiment, the 1.5-VDC pump is replaced by a 120-VAC aquarium air pump (Apollo™ 5). This AC pump was used during laboratory measurements to determine the linearity of air flow through porous media under conditions similar to those for the 1.5-VDC pump, as reported herein. A capillary tube was inserted in the supply line to reduce the nominal flow rate to approximate that of the 1.5-VDC air pump. All other equipment remained the same.

It was assumed and later verified that application of Darcy's law was valid for the low-pressure, moderate-flow permeameter of the present invention with either the contact or the insertion probe. Therefore, influences of gas slippage, gas compression, and inertial forces, were ignored (for more details about high-pressure or high air velocity calculations, see Goggin et al., A Theoretical and Experimental Analysis of Mini-Permeameter Response Including Gas Slippage and High Velocity Flow Effects, IN SITU 12:79-116 (1988)). Assuming an isotropic, homogeneous soil, and taking the geometry of the probes into account, we state

$$k = \frac{μ}{DG} \frac{Q}{Δ P} \qquad [ 1 ]$$

where k is the permeability of the porous medium to air [L²], μ is the air dynamic viscosity [M.L⁻¹.T⁻¹], Q is the air flow rate supplied by the pump [L³ T⁻¹], D is the inside diameter of the probe [L], G is a geometric factor [−] depending on the type and the dimensions of the probe used, and ΔP is the pressure difference between the air inside the probe, above the soil surface, and the free atmosphere [M.L⁻¹.T⁻²]. It should be mentioned that the use of Eq. [1] tacitly assumes a uniform water content distribution over the measured soil volume. As the air permeability changes with water content, the latter should be reported as well. We will now discuss the parameters occurring in Eq. [1].

Dry air viscosity is mainly dependent on temperature. The approximation

μ=(1717+4.8×T)×10⁻⁸ Pa.s [2]

where T is the temperature in ° C., shows a deviation of less than 0.15% from published data in the range −10° C.<T<40° C. The relative influence of humidity on air viscosity is less than 1% for these temperatures and atmospheric pressures greater than 77 kPa, and can thus be neglected for all practical purposes.

For contact probes, analytical and numerical solutions of the flow behavior in the vicinity of the probe have been derived by Tartakovsky et al. The rigorous geometric factor values they obtained for different D/D₀ ratios, while neglecting inertial forces, are reported in the data table of FIG. 3, which shows the Geometric factor G for contact probes as a function of probe dimensions D/D₀. The value for G tends towards 2 when D/D₀→0, and thus the geometric factor becomes conceptually related to, e.g., the electrical capacitance of a conducting disk. The empirical relationship

G=(1+0.36×η)(1.47−ln) [3]

where η=1−D/D₀ shows less than 0.2% deviation from published values for D/D₀≦0.98 (FIG. 3). However, values of D/D₀ greater than 0.8 are not recommended as this will result in limited measurement volumes prone to high variability.

For insertion probes, G has been numerically calculated by Liang et al. (1995). However, this calculation was affected by a limited simulation volume. Following a similar approach, G is calculated for D/H=0.25, 0.5, 1, 2, 4, 6, 8, 10, using the finite element code Hydrus-2D ( [symbol] im [symbol] nek et al., 1996). The soil volume over which the simulations were performed had a diameter greater than 25 times D and 20 times H, and a depth greater than 15 times D and 10 times H. A no-flow condition was applied to any boundary below the simulated soil surface. The probe thickness was taken as D/20. Between 8,000 and 10,000 mesh nodes were used for each calculation, and the triangular element density was increased near the bottom edge of the probe. It was observed that as D/H tends to 0, and as the volume subjected to flow inside the probe becomes negligible compared to the volume subjected to, for example, 99% of the flow in the soil outside the probe, the pressure at the bottom of the probe tends to atmospheric. Consequently, when D/H→0, the value for G tends to (π/4)×(D/H), which is the geometric factor for a simple soil column. This limit behavior was also observed by extrapolation of the quantity G/(D/H) to D/H=0, and agrees with the data review of Liang et al. (1995). The approximation

$$G ( \frac{D}{H} ) = ( \frac{π}{4} + \frac{D}{H} ) {( 1 + \frac{D}{H} )}^{- 1} ln ( 1 + \frac{D}{H} ) \qquad [ 4 ]$$

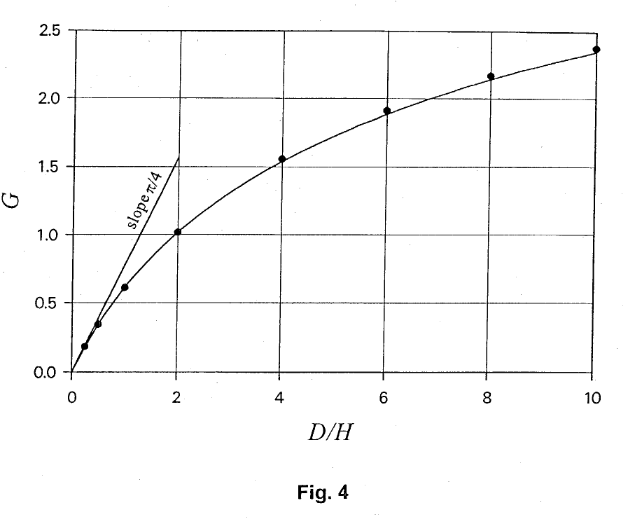

satisfies the limit behavior for G when D/H=0, and shows less than 1.5% relative deviation from our numerical results for D/H≦0 (FIG. 4). These numerical results generally agree with the geometric factors obtained by Liang et al. (1995) using their code ANSYS B, even though their simulations used a limited volume around the probe. For the same reason as discussed above for contact probes, D/H ratios greater than 10 are not recommended.

Because the air pump 14 is not compensated for the influence of back-pressure, the volumetric flow rate Q decreases with increasing values of ΔP. However, the ratio Q/ΔP of interest for permeability measurements remained a monotonic function of the voltmeter reading U. The permeameter is calibrated by measuring Q/ΔP as a function of the voltmeter reading U. To accomplish this, a mechanical flow rate meter with a variable resistance, resembling flow through porous media with different air permeabilities, is used. For a given air flow rate Q, a water manometer is used to measure the pressure difference ΔP between the inlet and outlet of the flow rate meter. The outlet is open to the atmosphere. The ratio Q/ΔP is subsequently calculated and related to U by simulteneously measuring the output of the pressure transducer, which is also connected to the bottom of the flow rate meter. One point of the permeameter characteristic or calibration curve Q/ΔP as a function of U is thus obtained. Additional points result by repeating the same procedure, but using different values for the resistance to air flow.

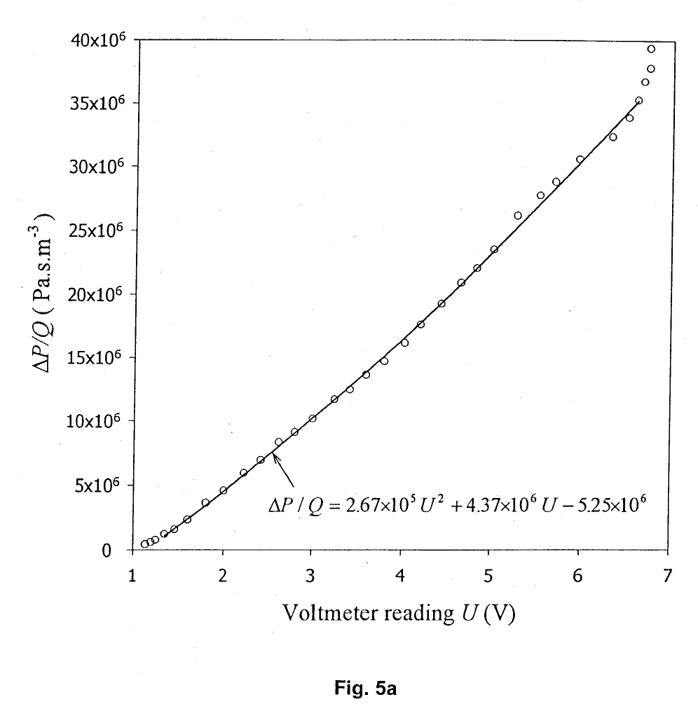

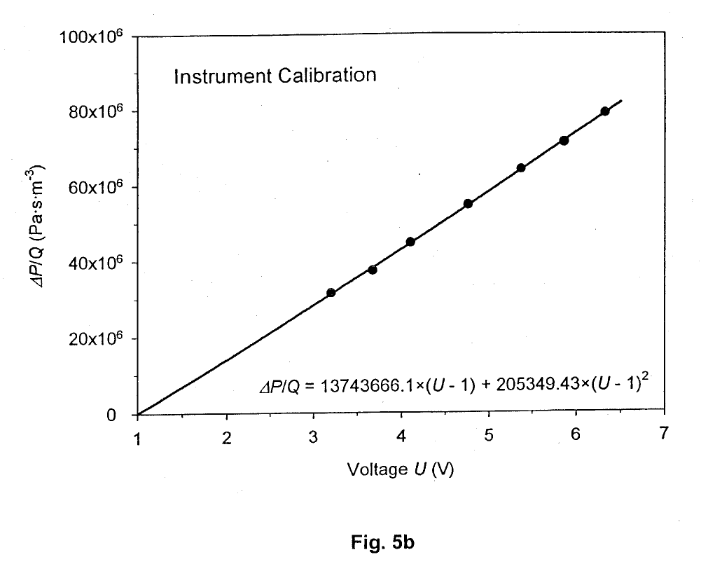

The calibration curve in the form of ΔP/Q as a function of U for the 1.5-VDC pump is presented in FIG. 5a, while the curve for the 120-VAC pump is displayed in FIG. 5b. If the pumps delivered a constant flow rate throughout the applied pressure range, ΔP/Q as a function of U should be a straight line. Limiting the measurements to values of U between 1.35 V and 6.60 V, for a pressure transducer set at 1.00 V at atmospheric pressure and having an upper limit of 6.73 V (FIG. 5), the device is suitable for permeability measurements between 5 and 150 μm² if equipped with a probe having G=2 and D=5 cm. Many naturally occurring dry surface soils lie in this range. However, an alternate embodiment could widen the measurement range by allowing selection of values for the pump supply voltage other than 1.5 V. The measurement range can also be adjusted by varying the dimensions and geometric factor of the probe used. In the indicated measurement range, the permeameter characteristic curves were fitted with quadratic expressions (FIG. 5) to simplify the conversion between voltmeter readings and AP/Q. The quadratic functions exhibit relative deviations of no greater than 10% from the calibration data.

Permeability values were obtained with both probe types in large containers filled with isotropic sands and dry surface soils. The containers were large enough to satisfy zero flow at the boundaries, as assumed during the determination of the geometric factors. For each porous medium, an air permeability measurement using the contact probe (D=25 mm, D₀=65 mm, G=2.39, rubber foam thickness=10 mm) was carried out first. Next, the insertion probe (tin can; D=95 mm) was pushed into each porous medium to a depth H=25 mm and a measurement was obtained (G=1.50, Eq. [4]). Four well-graded sands (Flintshot Ottawa sand, F&S Abrasives, Birmingham, Ala.: FS 12, 14, 55, 75) referred to as CS, MS, FS and VFS for coarse, medium, fine, and very fine sand, respectively, and three dry, natural top soils, referred to as TNH, TNL, and ALH. These natural soils varied between a sandy loam and a loamy sand with the TNH having the highest organic matter content and the TNL the lowest (Dane et al., 1997). The soils were passed through a 2-mm sieve before being placed in the containers. The air permeability value for the coarse sand, measured with the insertion probe (tin can), was calculated from direct application of the calibration data, because the voltmeter reading was slightly outside the range of validity of the quadratic equation shown in FIG. 5a.

Additional measurements were obtained in situ on a very coarse sand and a medium sand on experimental plots located on the Auburn University Turf Grass Management Unit, and on a bare sandy loam soil in an agricultural field. These in situ measurements were carried out with insertion probes only (tin can and modified cup cutter).

To check for linear flow, a packed sand column of 10 cm height and 4.9 cm inside diameter was subjected to a series of known flow rates Q, while simultaneously measuring ΔP with a water manometer. For the Darcy equation to hold, a plot of Q versus ΔP should result in a straight line relationship according to:

$$q = \frac{Q}{A} = - \frac{k}{μ} \frac{Δ P}{Δ z} \qquad [ 5 ]$$

where A (m²) is the cross sectional area of the sample, Δz (m) is the height of the sample, and all other variables have been defined before. To make sure that the conditions during field measurement were no different, similar measurements were obtained on an undisturbed sandy loam soil sample (height=6.0 cm, diameter=5.35 cm).

Finally, the (intrinsic) permeability values determined with air and water were compared. The same undisturbed sample used to determine air permeability values was subsequently used to determine the saturated hydraulic conductivity (K, m.s⁻¹) values according to

$$q = - K \frac{Δ H}{Δ z} \qquad [ 6 ]$$

where ΔH (m) is the hydraulic head difference across the sample. The obtained K values were then converted to k values by

$$k = \frac{K μ}{{ρ}_{w} g} \qquad [ 7 ]$$

where ρ_{w} (kg.m⁻³) is the density of water. To obtain complete saturation, the dry sample was first flushed with CO₂ and then saturated from the bottom with a deaerated 0.005 M CaCl₂ solution. During the upward flow a hydraulic head gradient of −1 was maintained. The sample was then subsequently dried and saturated again to obtain a second set of air and water permeabilities to check for repeatability.

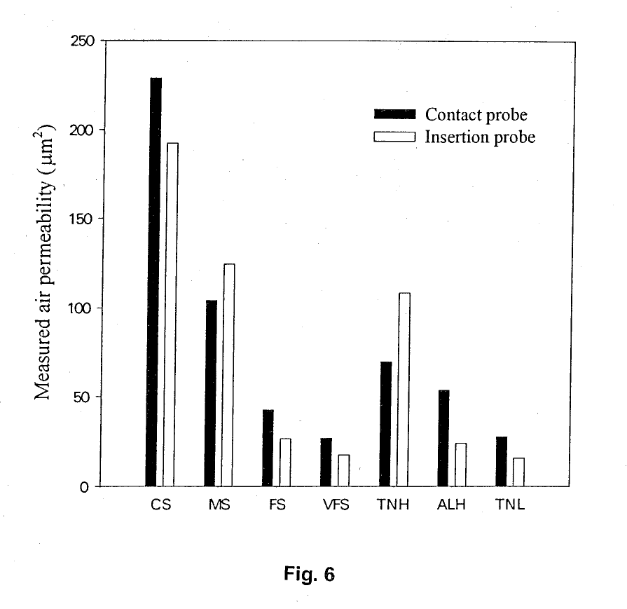

Contact probe measurements are sensitive to the (hand) pressure applied to the probe to promote good contact with the porous medium. If this pressure is insufficient, by-pass flow or even solid particle detachment may occur near the probe. Measurements were therefore obtained while manually applying pressure to the contact probe, without inducing significant soil compaction, until the voltmeter reading reached its highest, constant value (lowest permeability). FIG. 6 shows air permeability values obtained by using the contact probe and the insertion probe (tin can) on the four sands and three topsoils stored in the large containers. The relative deviation between values obtained with the contact and insertion probe appears acceptable for permeability measurements. Even though in most cases, contact probe measurements resulted in higher air permeability values than insertion probe measurements, no clear trend exists. The differences are believed to be attributed to differences in soil compaction, by-pass flow, and measurement volume associated with the two probe types. It is notable that, although the soil texture for the three topsoils was more or less the same, the air permeability decreased with decreasing organic matter content.

Although it was earlier stated that hydraulic conductivity values cannot be directly determined from air permeability values, because of gas slippage, etc., permeability values determined with air on dry soils should nevertheless be comparable with permeability values determined with water on saturated soils, assuming no water-solid phase interactions. In other words, dependent on the conditions, the values should not be too much different from the intrinsic permeability values of the different soils. Saturated hydraulic conductivity values have been independently studied and reported (Dane et al. 1999) for the coarse sand (CS), the fine sand (FS), and the very fine sand (VFS), and converted to permeability values. The outcome was 132, 36.2, and 11.1 μm², for the CS, the FS, and the VFS, respectively. These values compare quite favorably with those reported in FIG. 6. Based on mean grain diameters, the permeability values for the sands also compared favorably with other reported intrinsic permeability values.

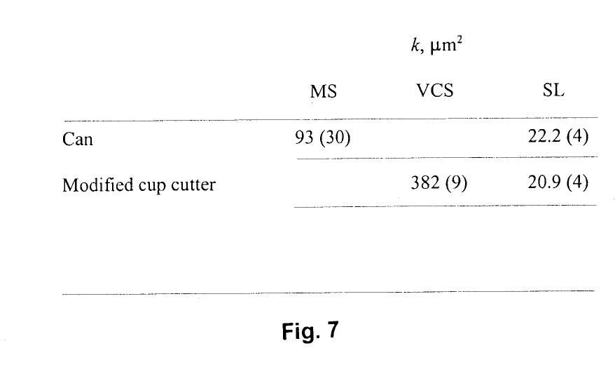

Air permeability values were obtained in situ in a sandy loam (SL) agricultural field and on experimental turf grass management plots containing a very course (VCS) and a medium sand (MS). The results are presented in the table of FIG. 7. Compared to the data presented in FIG. 6, the in-situ measured values are of the same magnitude. It should also be mentioned that the values obtained for the sandy loam with the tin can and the modified cup cutter compare very well, indicating the usefulness and accuracy of the easier to use modified cup cutter probe.

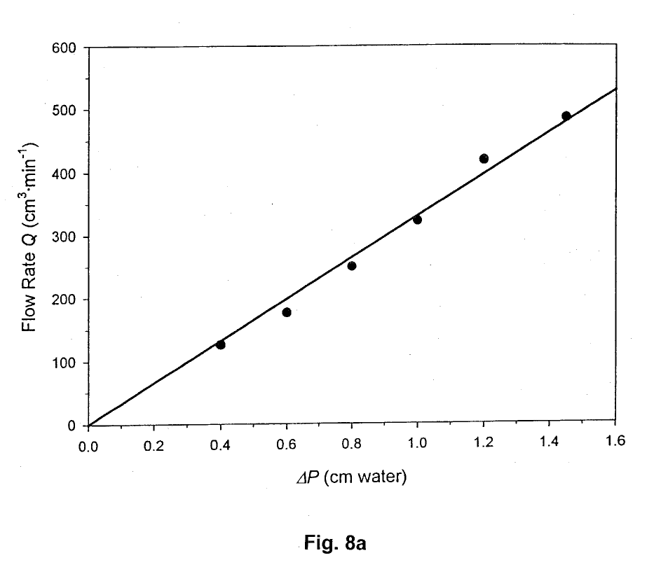

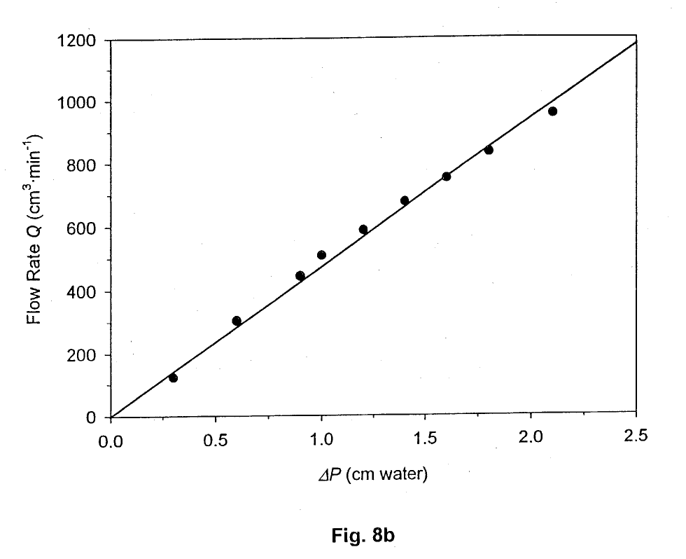

The linearity of the flow, the basis of the use of Eq. [1], was checked on packed sand columns for embodiments of the device of the present invention using both the DC and AC air pumps. In the range of flow rates applied during sample measurements, linear relationships were obtained with r² values of 0.984 and 0.992 for the 1.5-VDC and the 120-VAC pumps, respectively (FIG. 8a, 8b).

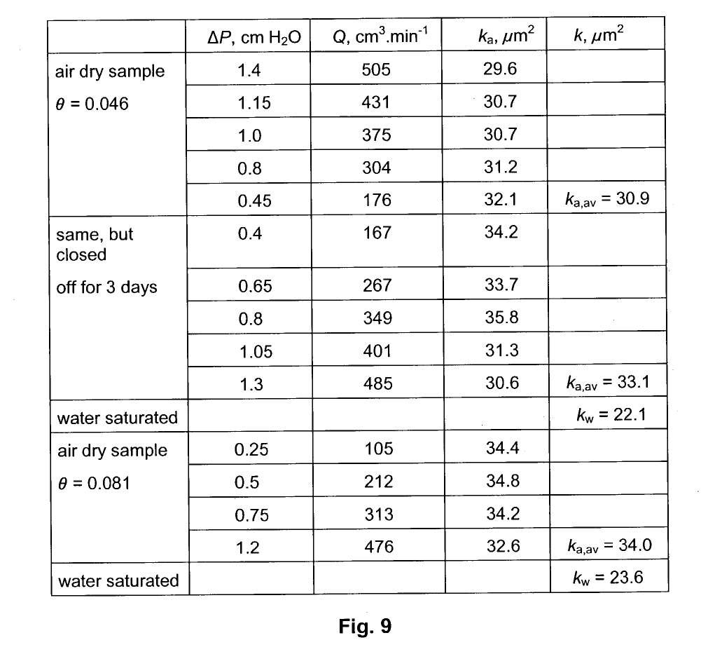

Finally, to assure that air flow behaved similarly through undisturbed soil as through packed sand samples, k values were measured on an undisturbed sandy loam sample. The same sample was subjected to saturated hydraulic conductivity measurements to allow comparison of permeability values determined with air and water. The results are reported in the table of FIG. 9. The first set of data (air dry sample, θ=0.046), was obtained without any measures to promote a uniform water distribution. Before obtaining the second set of data, however, the sample was capped at both ends and rotated for 3 days to promote a uniform water distribution. The average value for the permeability only slightly increased from 30.9 to 33.1 μm². The subsequent permeability determined with water yielded a value of 22.1 μm². A repeat of the measurements resulted in an average value of 34.0 for air and a value of 23.6 μm² for water. Hence, on average, the ratio of the air permeability to water permeability was 1.43. The difference may be in large part due to water-solid phase interactions, despite the precaution of using a salt solution. Other contributing factors that were ignored are gas slippage, gas compression, and inertial forces. It should be noted that for all air data sets, the permeability varied only slightly, again indicating linear flow for the existing conditions.

For a soil exhibiting local anisotropy with a vertical permeability k_{z} and a horizontal permeability kᵣ, permeability measurements performed with contact and insertion probes should be different. It has previously been shown that for contact probes, the air permeability value, \overline{k}, obtained while assuming an isotropic soil, is the geometric average of the two permeability components, i.e.:

\overline{k}=\sqrt{kᵣk_{z}} [8]

Using a change of variables, it can be shown that for insertion probes:

$$\overline{k} = \sqrt{{k}_{r} {k}_{z}} G ( \sqrt{\frac{{k}_{z}}{{k}_{r}}} \frac{D}{H} ) / G ( \frac{D}{H} ) \qquad [ 9 ]$$

where an approximation to the function G(D/H) is given by Eq. [4]. Theoretically, an assessment of the soil's level of anisotropy is possible by measuring \overline{k}, then excavating the probe and the soil contained in it to allow for a measurement of k_{z}, using the same permeameter and following the approach of Iversen et al. (2001). The probe thus becomes an open-ended column with geometric factor (π/4)×(D/H). Equation [9] can then be solved for kᵣ. However, it should be kept in mind that the \overline{k} and k_{z} measurements are not performed on the same sampling volume and care should be taken in the interpretation of the results.

Due to compaction and particle movement problems associated with the contact probe, its use is not recommended for very compressible soils such as peat or freshly tilled soils. However, most field soils are expected to have some level of consolidation and resistance to compression. To prevent air by-pass, the overburden pressure on the contact probe can be reduced by smoothing the soil surface. The contact probe may, however, be the only possibility to measure field air permeability of very consolidated soils in which an insertion probe cannot be entered without significantly disturbing the soil. Finally, since most field soils dry rapidly near the surface, contact probe measurements would be less influenced by the subsurface moisture status than insertion probe measurements.

In alternate embodiments, the device of the invention further comprises a data acquisition unit, a global positioning system (GPS), and a device such as a thermistor or thermocouple to measure air temperature. The data acquisition system will allow the measured voltage values to be stored in memory. It will also allow input and storage of additional information such as location number of the test site, date, time, location of the test site as determined by the GPS, probe type (insertion or contact), probe diameter, depth of insertion in case of the insertion probe, and/or air temperature. In other embodiments, the device of the invention includes one or more microprocessors or other computing means, which will allow calibration curves and/or data to be entered and stored as well as the equations to determine the geometric factor and the air viscosity. The device will then be able to almost instantaneously provide the air permeability value based on the information provided and the voltage measured with the pressure transducer 16, while simultaneously placing the value into storage.

While the invention has been described with reference to preferred and example embodiments, it will be understood by those skilled in the art that a variety of modifications, additions and deletions are within the scope of the invention, as defined by the following claims.

What is claimed is:

1. A device for measuring air permeability of soil, comprising:
a contact probe;
an insertion probe;
a pump for pumping a fluid to a selected one of the contact probe and the insertion probe;
a pressure transducer for measuring a pressure differential; and
an output device for reporting the measured pressure differential.

2. The device of claim 1, operable to measure air permeability without flowrate control.

3. The device of claim 1, comprising valving for selective switching between the contact probe and the insertion probe.

4. The device of claim 1, comprising a detachable coupling for selective switching between the contact probe and the insertion probe.

5. The device of claim 1, wherein the insertion probe comprises a smooth, sharpened cutting edge.

6. The device of claim 1, wherein the contact probe comprises a compressible foam annular rim.

7. The device of claim 1, wherein the contact probe has an annular contact surface with an internal diameter D and an external diameter D₀, and wherein D/D₀ is not greater than 0.8.

8. The device of claim 1, wherein the insertion probe has a diameter D and is inserted into soil to a depth H, and wherein D/H is not greater than 10.

9. A device for measuring the permeability of soil, comprising:
a pump for delivering a fluid under pressure;
a detachable coupling for delivering the fluid under pressure from the pump to a probe selected from a contact probe and an insertion probe; and
means for measuring a pressure of the fluid delivered to the selected probe and determining a soil permeability value based on the measured pressure.

10. The device of claim 9, further comprising a DC power source for energizing said pump.

11. The device of claim 9, wherein said means for measuring a pressure of the fluid delivered to the selected probe and determining a soil permeability value based on the measured pressure comprise a pressure transducer and a voltmeter.

12. The device of claim 9, wherein said means for measuring a pressure of the fluid delivered to the selected probe and determining a soil permeability value based on the measured pressure uses a probe geometric factor of the selected probe in determining the soil permeability value.

13. The device of claim 9, wherein a soil permeability value, k, is determined based on:
a dynamic viscosity, μ, of the fluid;
an inside diameter, D, of the probe;
a geometric factor, G, depending on the type and dimensions of the selected probe; and
a ratio, ΔP/Q of the pressure difference, ΔP, between fluid inside the selected probe and the free atmosphere, and a flow rate, Q, of the fluid.

14. The device of claim 13, wherein the soil permeability value is determined based on Darcy's law:
$$k = \frac{μ}{DG} \frac{Q}{Δ P} .$$

15. A method of determining the permeability of soil, said method comprising:
providing a soil permeability measurement device with interchangeable probes including a contact probe and an insertion probe;
delivering a fluid under pressure to a selected one of said contact probe and said insertion probe; and
measuring a pressure of the fluid delivered to the selected probe and determining a soil permeability value based on the measured pressure.

16. The method of claim 15, further comprising using a probe geometric factor of the selected probe in determining the soil permeability value.

17. The method of claim 15, wherein the soil permeability value, k, is determined based on:
a dynamic viscosity, μ, of the fluid;
a flow rate, Q, of the fluid;
an inside diameter, D, of the selected probe;
a geometric factor, G, depending on the type and dimensions of the selected probe; and
a pressure difference, ΔP, between fluid inside the probe and the free atmosphere.

18. The method of claim 17, wherein the soil permeability value is determined based on Darcy's law:
$$k = \frac{μ}{DG} \frac{Q}{Δ P} .$$
